(19) United States
(12) Patent Application Publication
(10) Pub. No.: US 2026/0328290 A1
(43) Pub. Date: Oct. 22, 2026

(54) CONVEYING DEVICE AND MECHANICAL SEAL ASSEMBLY COMPRISING SUCH A CONVEYING DEVICE

(71) Applicant: EagleBurgmann Germany GmbH & Co. KG, Wolfratshausen (DE)

(72) Inventors: Josef Widmann, Wolfratshausen (DE); Florian Wasensteiner, Königsdorf (DE); Hans Steigenberger, Eurasburg (DE)

(73) Assignee: EagleBurgmann Germany GmbH & Co. KG, Wolfratshausen (DE)

(21) Appl. No.: 19/101,479

(22) PCT Filed: Aug. 14, 2023
(86) PCT No.: PCT/EP2023/072387

§ 371 Date: Feb. 5, 2025

(30) Foreign Application Priority Data
Sep. 22, 2022 (DE) 10 2022 122 319.1

(51) Int. Cl. F16J 15/34

(52) U.S. Cl. CPC F16J 15/3404

(57) ABSTRACT

The invention relates to a conveying device for conveying a liquid, comprising a rotatable part (61) and a stationary part (62), wherein a conveying gap (63) is present between the rotatable part (61) and the stationary part (62), and wherein a Tesla valve-like conveying channel (63) is formed on the rotatable part (61) and/or on the stationary part (62), wherein the conveying channel (63) has a greater flow resistance in one flow direction than in the other flow direction.

### DESCRIPTION

The invention relates to a conveying device, in particular a mechanical seal, for conveying a liquid in an axial direction, and a mechanical seal assembly comprising a mechanical seal and a conveying device according to the invention.

Conveying devices are known in conjunction with mechanical seals for example as conveying threads, for conveying a coolant and/or a barrier fluid in the direction of the slide rings and the sealing gap. A conveying thread of this kind is known for example from DE 10 2011 118 477A1 . This document discloses a conveying thread that is mounted in a floating manner, in order to prevent contact, during operation, on the conveying thread with surrounding housing parts. A disadvantage of all the conveying threads known hitherto is that, in the case of a reversal of the direction of rotation at the shaft, the conveying direction in the conveying thread also reverses. As a result, it is not always possible to ensure, during use of such conveying threads, that sufficient coolant or barrier fluid is conveyed at the desired locations.

An object of the present invention is that of providing a conveying device for conveying a liquid which, with a simple structure and simple, cost-effective producibility, allows for reliable conveying of large conveying amounts. A further object of the invention is that of providing a mechanical seal assembly comprising a conveying device which conveys sufficient amounts of liquid in all operating states.

This object is achieved by a conveying device having the features of claim 1 and a mechanical seal assembly having the features of claim 10. Preferred developments of the invention are shown in the dependent claims.

The conveying device according to the invention for conveying a liquid having the features of claim 1 has the advantage, in contrast, that it is possible to also convey larger amounts of liquid, such as coolant or barrier fluid, in particular to a mechanical seal. The conveying device can also be used for conveying lubricant or other liquids. In this case, the conveying device according to the invention comprises a rotatable part and a stationary part. A conveying gap is present between the rotatable part and the stationary part, via which gap the liquid to be conveyed is conveyed. Furthermore, a Tesla conveying channel configured in the manner of a Tesla valve is provided at least on the rotatable part or the stationary part. The Tesla valve-like conveying channel has a configuration similar to a Tesla valve, which is a type of non-return valve without movable mechanical components. In this case, the Tesla valve-like conveying channel has a greater flow resistance in one conveying direction than in an opposing conveying direction. Thus, a backstop is achieved by hydrodynamic effects in the opposite direction. The Tesla vertical-like conveying channel is formed entirely in the rotating or stationary part, or a Tesla vertical-like conveying channel is formed in each case in the rotating and stationary part.

The Tesla valve-like conveying channel preferably comprises a plurality of alternately arranged narrowing regions and widening regions. The widening regions are preferably leaf-like or surface-like widenings, or alternatively a separate flow channel having a longer flow length than a main channel of the Tesla valve-like conveying channel.

The widening regions are preferably curved. The widening regions are arranged along a flow direction, alternately on the left and right, on a conveying channel axis.

The conveying channel is preferably arranged at an acute angle α to the axial direction. The acute angle α is preferably in a range of 60° to 89°, preferably 70° to 80°, of the axial direction X-X of the conveying device. A conveying amount can be influenced by selecting the angle α.

Particularly preferably, the conveying device comprises a plurality of Tesla valve-like conveying channels arranged in parallel with one another. This also results, in the case of conveying in the axial direction X-X, in a transfer of the liquid from a first conveying channel to a neighboring second channel. The Tesla-like conveying channels are preferably each formed entirely in lateral surfaces of the rotating and/or stationary part.

A particularly simple structure is possible if the rotatable part is a ring, on the outer periphery of which the conveying channel is arranged, or if the stationary part is a ring, on the inner periphery of which the conveying channel is arranged. If the conveying channel is arranged on the outer periphery, the rotatable part can for example be fastened in a simple manner on a shaft or the like. If the conveying channel is arranged on an inner periphery, the part of the conveying device can be fixed on a housing or the like. The ring and the shaft are preferably an integral component, such that the ring is integrated into the shaft.

According to a particularly preferred embodiment of the invention, at least one first Tesla valve-like conveying channel is arranged on the rotatable part and at least one second Tesla valve-like conveying channel is arranged on the stationary part. This can enable conveying that is independent of the direction of rotation.

Preferably, all the conveying channels on the rotatable part and/or on the stationary part are configured geometrically identically.

In this case, the first and second Tesla valve-like conveying channel is particularly preferably arranged at an acute angle to the axial direction, wherein the first and second conveying channel are oriented in the same direction. This makes it possible for the conveying direction of the conveying device to remain the same, even in the case of a reversal in the direction of rotation of the rotatable part. In other words, in the case of a first direction of rotation the conveying device conveys in a first direction, and in the case of reversal of the conveying device in a direction opposite to the first direction of rotation the conveying device still conveys in the first direction. This can be used advantageously in particular in the case of mechanical seals which have to provide sealing on rotating components, the direction of rotation of which changes during operation. As a result, for a mechanical seal of this kind the conveying device can convey coolant and/or barrier liquid to the mechanical seal reliably and in large, required quantities, irrespective of the direction of rotation of the rotating component. The present invention further relates to a mechanical seal assembly comprising a mechanical seal having a rotating and a stationary slide ring which define a sealing gap between their sliding surfaces. The mechanical seal assembly comprises a conveying device as described above.

The mechanical seal assembly further preferably comprises a barrier fluid device, wherein the conveying device according to the invention conveys the barrier fluid to the sealing gap of the mechanical seal. Further preferably, the mechanical seal assembly comprises a cooling device, wherein the conveying device according to the invention conveys a coolant to the mechanical seal.

The conveying device according to the invention can in particular also preferably be used as a lubricant pump, for example for supplying lubricant to bearings or other rotating components.

Preferred embodiments of the invention are described in detail in the following, with reference to the accompanying drawings, in which:

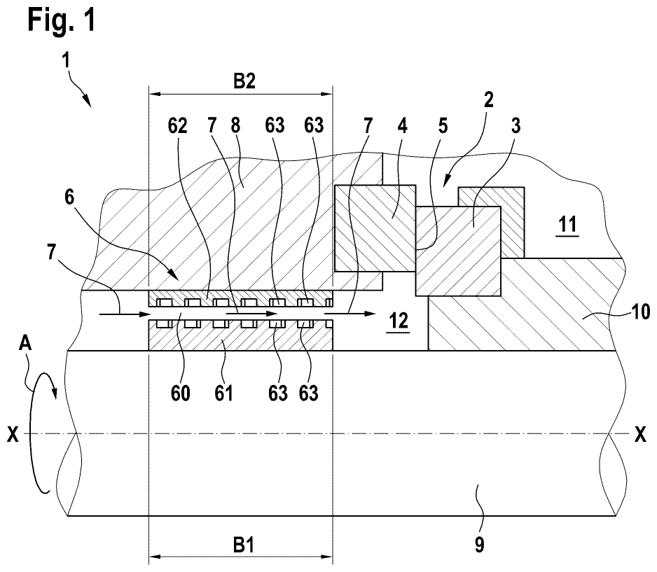

FIG. 1 is a schematic sectional view of a mechanical seal assembly comprising a conveying device according to a first embodiment of the invention,

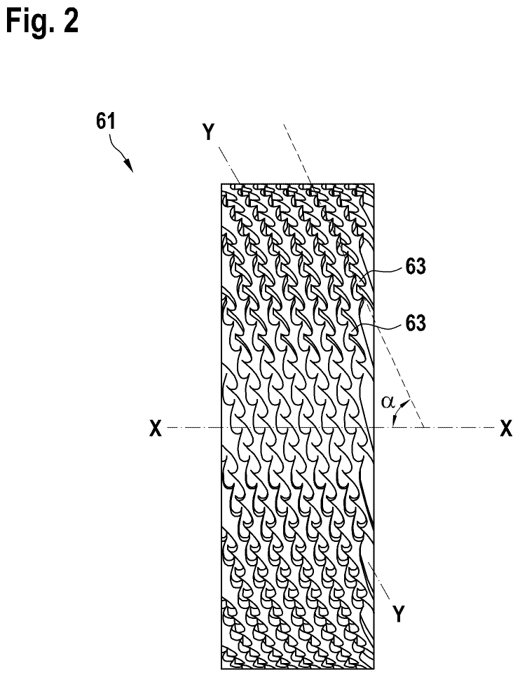

FIG. 2 is a schematic plan view of a rotatable part of the conveying device of FIG. 1,

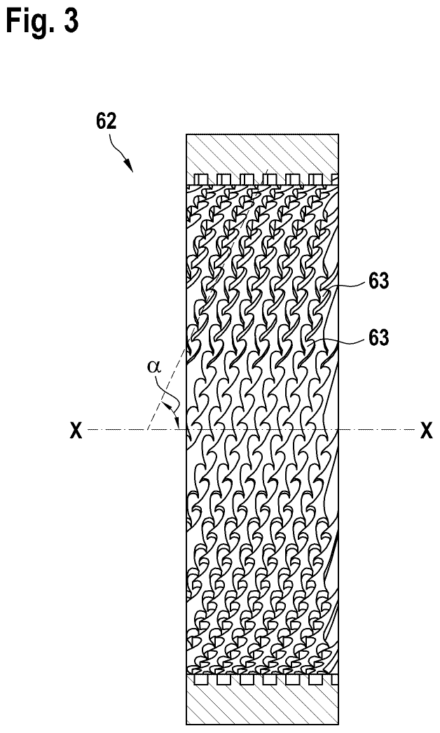

FIG. 3 is a schematic sectional view of a stationary part of the conveying device of FIG. 1,

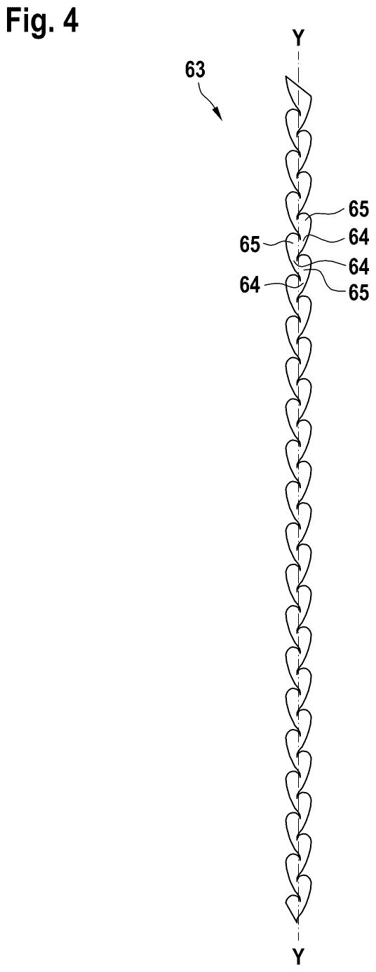

FIG. 4 schematically shows a development of a Tesla valve-like conveying channel of the conveying device of FIG. 1,

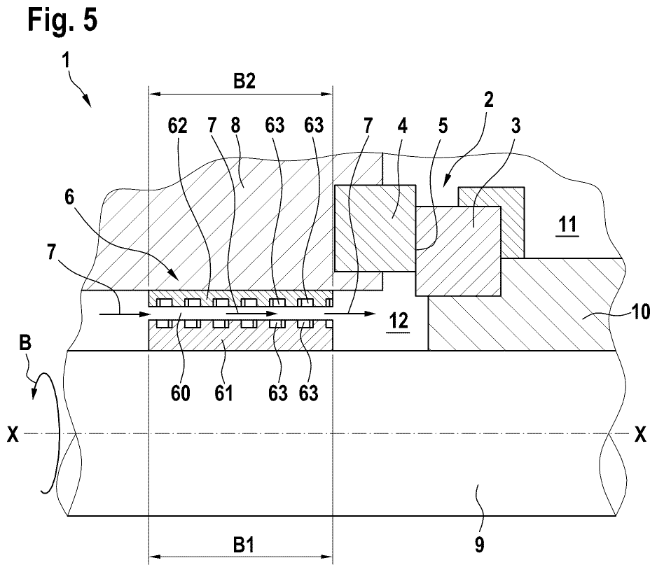

FIG. 5 is a schematic sectional view of the mechanical seal assembly comprising the conveying device of FIG. 1, in the case of a reversed direction of rotation, and

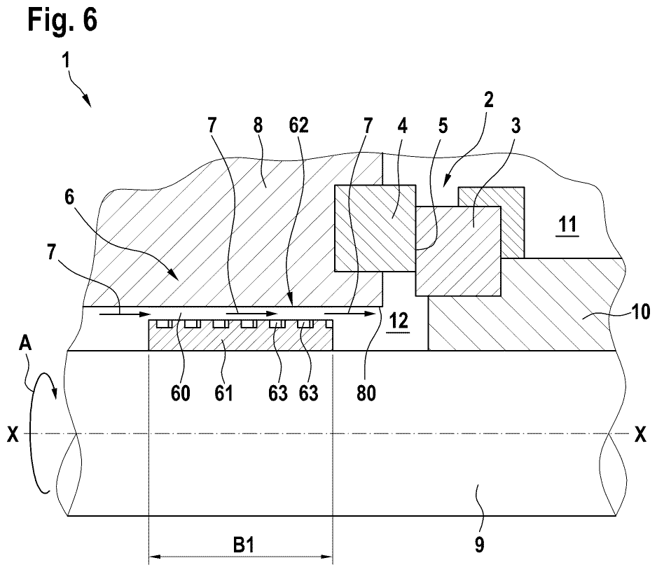

FIG. 6 is a schematic sectional view of a mechanical seal assembly comprising a conveying device according to a second embodiment of the invention.

A mechanical seal assembly 1 according to a first preferred embodiments of the invention is described in detail in the following, with reference to FIG. 1 to 5.

As can be seen from FIG. 1, the mechanical seal assembly 1 comprises a mechanical seal 2 comprising a rotating slide ring 3 and a stationary slide ring 4. A sealing gap 5 is defined between the sliding surfaces of the rotating slide ring 3 and the stationary slide ring 4.

In this case, the mechanical seal assembly 1 seals a product region 11 at a shaft 9 from a region 12 to be sealed.

The rotating slide ring 3 is connected to the shaft 9 via a bushing 10. The stationary slide ring 4 is fixed to a housing 8.

The mechanical seal assembly 1 further comprises a conveying device 6 which is configured for conveying a liquid. As can be seen from FIG. 1, the conveying device 6 comprises a rotatable part 61 and a stationary part 62. The rotatable part 61 is arranged directly on the shaft 9. The stationary part 62 is arranged on the housing 8.

A conveying gap 60 is arranged between the rotatable part 61 and the stationary part 62. In this case, the conveying device 6 conveys in the axial direction X-X of the mechanical seal assembly, wherein FIG. 1 shows the liquid flow in the flow direction 7.

The rotatable part 61 and the stationary part 62 each comprise one or more conveying channels 63. The conveying channels are configured as Tesla valve-like conveying channels. Each of the conveying channels is formed entirely in the rotating and stationary part.

FIG. 2 shows the rotatable part 61 of the conveying device 6 in detail. As can be seen from FIG. 2, a plurality of conveying channels 63 arranged in parallel with one another is arranged on the rotatable part 61. In this case, the conveying channels 63 are arranged at an acute angle a to the axial direction X-X (cf. FIG. 2).

FIG. 3 is a schematic sectional view of the stationary part 62 of the conveying device 6. As can be seen from FIG. 3, the stationary part 62 comprises a plurality of conveying channels 63 on its inner periphery, which channels are also arranged at the same angle a to the axial direction X-X, on the inner periphery. In this case, too, a plurality of conveying channels 63 is arranged in parallel with one another.

As follows directly from a comparison between FIGS. 2 and 3, in the rotatable part 61 and the stationary part 62 the conveying channels are oriented in the same direction. Thus, the conveying channels 63 of the rotatable part 61 and of the stationary part 62 extend in parallel with one another.

FIG. 4 schematically shows a development of a conveying channel 63. The conveying channels are configured in the same way in the rotatable part 61 as in the stationary part 62.

As can be seen from FIG. 4, each conveying channel 63 comprises narrowing regions 64 and widening regions 65. Each conveying channel 63 comprises a plurality of alternately arranged narrowing regions 64 and widening regions 65. The widening regions 65 are planar curved regions which are arranged in a leaf-like manner along a main direction, alternately on the left and right, on a conveying channel axis Y-Y. In each case a narrowing region 64 is provided between two widening regions 65. This embodiment results in a greater flow resistance in one direction of the conveying channel 63 than in the other direction of the flow channel.

In order for the conveying to be possible in the same axial direction in each case, irrespective of a direction of rotation, the Tesla valve-like conveying channel 63 is arranged on the stationary part 62 of the conveying device 6 in the same direction as on the rotatable part and at the same angle. This makes it possible for the conveying device 6, as shown in FIG. 1, to convey a liquid in a first direction of rotation A, by means of the conveying channels 63 in the rotatable part 61, in the flow direction 7 through the conveying gap 60, wherein the conveying channels in the stationary part block a passage of fluid by a hydrodynamic effect. As shown in FIG. 5, in the case of an opposing direction of rotation B, the conveying channels 63 of the rotatable part 61 provide a block, while liquid is conveyed in the conveying channels 63 of the stationary part 62, such that conveying occurs in the same direction (flow direction 7), by means of the conveying channels 63 in the stationary part 62, through the conveying gap 60. Since the angle and the geometric shape of the conveying channels 63 in the rotatable and stationary part are the same, the amount of liquid conveyed is also the same.

Thus, a delivery rate of the conveying device that is independent of the direction of rotation can always be made possible in the same direction through the conveying gap 60. It is noted that different conveying amounts can preferably also be conveyed, by varying the angle a on the rotatable and stationary part, depending on a direction of rotation. Thus, the invention can provide a conveying device 6 which is capable of conveying the same or a different amount of liquid in the same direction, irrespective of a direction of rotation of a rotatable part 61.

Since in the first embodiment a width B1 of the rotatable part 61 and a width B2 of the stationary part 62 of the conveying device 6 is the same, and also the angles a are the same, the conveyed amount of liquid in the flow direction 7 is also the same, irrespective of a direction of rotation (A or B).

FIG. 6 shows a mechanical seal assembly 1 according to a second embodiment of the invention. Identical or functionally identical parts are provided with the same reference signs as in the first embodiment. As can be seen from FIG. 6, the conveying device 6 of the second embodiment comprises a rotatable part 61 which, as in the first embodiment, comprises conveying channels 63 having narrowing regions 64 and widening regions 65. The rotatable part 61 is arranged directly on the shaft 9. In the second embodiment, the stationary part 62 of the conveying device 6 is formed by a peripheral wall 80 of the housing 8. Thus, the conveying device 6 of the second embodiment has a significantly simplified structure and comprises conveying channels 63 of a Tesla valve type only on the rotatable part 61. If the conveying channels 63 of the rotatable part 61 are arranged, as in the first embodiment, at an acute angle to the axial direction X-X, conveying of large amounts in the direction of the flow direction 7 occurs, and in the case of a reversal of the direction of rotation the conveyed amount is significantly reduced and tends towards zero. The second embodiment is intended in particular for applications in which a reversal in the direction of rotation of the shaft 9 to be sealed does not occur. As a result, a structure of the conveying device 6 can be configured in a simpler and more cost-effective manner. Otherwise, this embodiment corresponds to the first embodiment, and therefore reference can be made to the description given there.

In addition to the above written description of the invention, for the additional disclosure thereof reference is hereby explicitly made to the illustrations of the invention in FIG. 1 to 6.

### LIST OF REFERENCE NUMERALS

1 mechanical seal assembly
2 mechanical seal
3 rotating slide ring
4 stationary slide ring
5 sealing gap
6 conveying device
7 flow direction through the conveying gap
8 housing
9 shaft
10 bushing
11 product region
12 region to be sealed
60 conveying gap
61 rotatable part
62 stationary part
63 conveying channel
64 narrowing region
65 widening region
80 peripheral wall
A first direction of rotation
B second direction of rotation counter to the first direction of rotation
B1 width of the rotatable part
B2 width of the stationary part
X-X axial direction
Y-Y conveying channel axis
α angle

1. Conveying device for conveying a liquid, comprising
a rotatable part and
a stationary part,
wherein a conveying gap is present between the rotatable part and the stationary part, and
wherein a Tesla valve-like conveying channel is formed on the rotatable part and/or on the stationary part, wherein the conveying channel has a greater flow resistance in one flow direction than in the other flow direction.

2. Conveying device according to claim 1, wherein the conveying channel comprises a plurality of alternately arranged narrowing regions and widening regions.

3. Conveying device according to claim 2, wherein the widening regions are curved and are arranged alternately along a flow direction through the conveying channel, on a conveying channel axis (Y-Y).

4. Conveying device according to claim 1, wherein the conveying channel is arranged at an acute angle (α) to the axial direction (X-X).

5. Conveying device according to claim 4, wherein the acute angle (α) is in a range of 60° to 89°.

6. Conveying device according to claim 1, comprising a plurality of conveying channels arranged in parallel with one another.

7. Conveying device according to claim 1, wherein the rotatable part is a ring, on the outer periphery of which the conveying channel is arranged, and/or wherein the stationary part is a ring, on the inner periphery of which the conveying channel is arranged.

8. Conveying device according to claim 1, wherein all the conveying channels are configured to be geometrically identical.

9. Conveying device according to claim 1, wherein the conveying channel of the rotatable part and the conveying channel of the stationary part are arranged at the same angle (α).

10. Mechanical seal assembly comprising
a mechanical seal comprising a rotating slide ring and a stationary slide ring which define a sealing gap between their sliding surfaces, and
a conveying device according to claim 1.
